(19) United States
(12) Patent Application Publication
(10) Pub. No.: US 2009/0109559 A1
(43) Pub. Date: Apr. 30, 2009

(54) SIDE MOUNTED VEHICLE MIRROR WITH INTEGRAL OBJECT

(76) Inventors: Vernon D. Price, Springfield, TN (US); Brian K. Bell, White House, TN (US)

Correspondence Address: DAVID A. GREENLEE, P.O. BOX 340557, COLUMBUS, OH, 43234, US

(21) Appl. No.: 11/665,431

(22) PCT Filed: Oct. 14, 2005
(86) PCT No.: PCT/US05/37190

§ 371 Date: Jun. 26, 2008

Related U.S. Application Data
(60) Provisional application No. 60/619,500, filed on Oct. 15, 2004.

(51) Int. Cl. G02B 5/30

(52) U.S. Cl. 359/843

(57) ABSTRACT

A side object detection (SOD) system is integrated into the side view mirror assembly (10) of a vehicle to alert motor vehicle operators to the presence of another moving vehicle in a monitored zone. The SOD system combines an optical transmitter (26), an optical receiver (28), and a system board (30) electrically coupled to the optical transmitter and to the optical receiver

### TECHNICAL FIELD

The present invention relates generally to side object detection systems for motor vehicles. More particularly, the present invention pertains to positioning and mounting a side object detection system on a motor vehicle equipped with side view mirrors.

### BACKGROUND ART

Object detection systems have been developed to alert motor vehicle operators to the presence of another moving vehicle in a monitored zone that extends behind the side mounted vehicle mirror. The monitored zone of interest is commonly referred to as the “blind spot.” Conventional side object detection (SOD) systems use an optical transmitter to transmit detection beams through a transmitter lens into the monitored zone, a receiver to receive detection beams that pass through a receiver lens after being reflected from an object in the monitored zone, and a system board that contains electronic hardware and software for generally controlling the system, including processing the received signals. The system board is electrically coupled to a vehicle electrical bus. At a minimum, the vehicle electrical bus supplies operational power to the SOD system and may further include signal lines and data lines that connect to a vehicle data network and/or provide detection alert signals to the driver on the inside of the vehicle. One example of a vehicle SOD system that generally employs this architecture is described in U.S. Pat. No. 6,377,167, the content of which is incorporated herein in its entirety.

The mounting of a SOD system to a motor vehicle implicates both functional and aesthetic considerations. Preferably, the SOD system transmitter and receiver hardware are located near the side view mirror so that it is easier to create a monitored zone that corresponds to the vehicle blind spot. In fact, SOD systems have been marketed in which the transmitter, transmitter lens, receiver, and receiver lens have been separately packaged and attached to the outside of the frame of the vehicle side view mirror. The system board is physically located inside the mirror frame or inside the vehicle itself, with system cables running to the transmitter and receiver. This mounting configuration has several drawbacks. First, it requires separate weatherproof housings for the transmitter and receiver, which increases the cost. The external mounting also increases the risk of damage to the SOD system components. The exposure to accidental impact increases the risk that transmitter or receiver alignment will be disturbed which will thereby decrease the accuracy of the system. Also, suspending the transmitter and receiver housings below the mirror housing enlarges the physical profile of the side mirror assembly, which is aesthetically undesirable.

What is needed, then, is a side object detection system for a motor vehicle that can be packaged and mounted to the vehicle in a manner that reduces cost, increases reliability, and preserves vehicle appearance.

### DISCLOSURE OF THE INVENTION

The present invention integrates a SOD system into the side view mirror assembly of the vehicle. The side view mirror assembly has a frame attached to and extending away from a side of the vehicle. A mirror is positioned in a central portion of the frame. The frame has an exterior frame wall adjacent to the mirror and an interior frame cavity. The frame wall includes one or more frame segments that face rearwardly along the side of the vehicle.

The SOD system is entirely mounted in the mirror frame. The SOD system combines an optical transmitter, an optical receiver, and a system board electrically coupled to the optical transmitter and to the optical receiver. The optical transmitter and optical receiver each include a lens integral to at least one of the rearward facing segments of the frame wall. The SOD system board is positioned within the mirror frame cavity.

In one embodiment of the invention, a side rear view mirror apparatus for a motor vehicle includes a mirror housing attached to the side of the vehicle, with a mirror mounted to the housing. The housing has a bottom section positioned below the mirror. The bottom section includes a rearward facing exterior wall and an inner cavity. The SOD system combines a transmitter, a transmitter lens, a receiver, a receiver lens, and a system board electrically connected to the transmitter and receiver. The transmitter, receiver, and system board are each positioned entirely within the inner cavity of the bottom section of the mirror housing. The transmitter lens and receiver lens each define portions of the exterior wall of the mirror housing.

Preferably, the SOD system cable electrically connects the system board to the vehicle electrical bus. Only the system cable component of the SOD system extends outside of the mirror frame or housing.

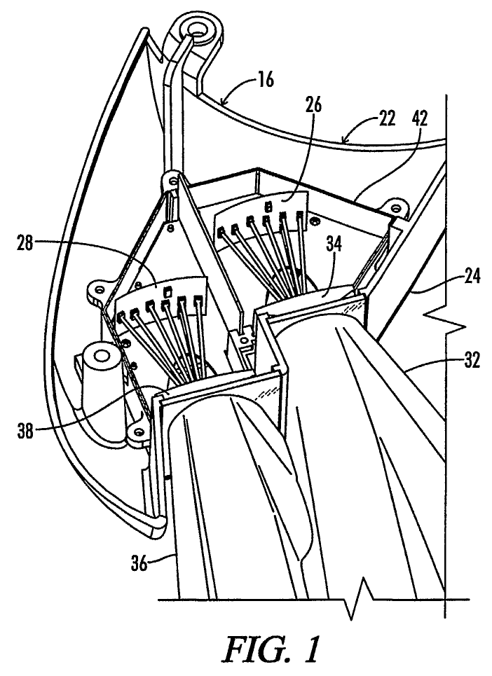

FIG. 1 is a top perspective view of the bottom section of a vehicle side mirror housing (shown detached from the top section) with an integrally mounted side object detection system in accordance with the present invention, further showing the SOD system enclosure with the cover removed, exposing the transmitter and receiver positioned therein.

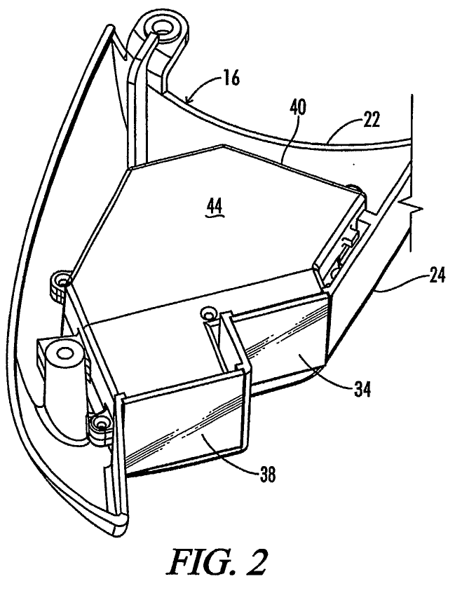

FIG. 2 is a top perspective view of the invention as shown in FIG. 1, with the cover attached to the SOD system enclosure.

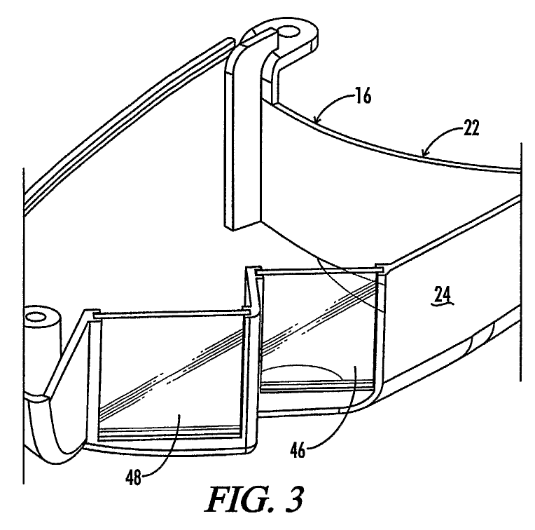

FIG. 3 is an enlarged top perspective view of the bottom section of the mirror housing shown in FIG. 1, further showing the transmitter lens and receiver lens integral with the rearward facing outside wall.

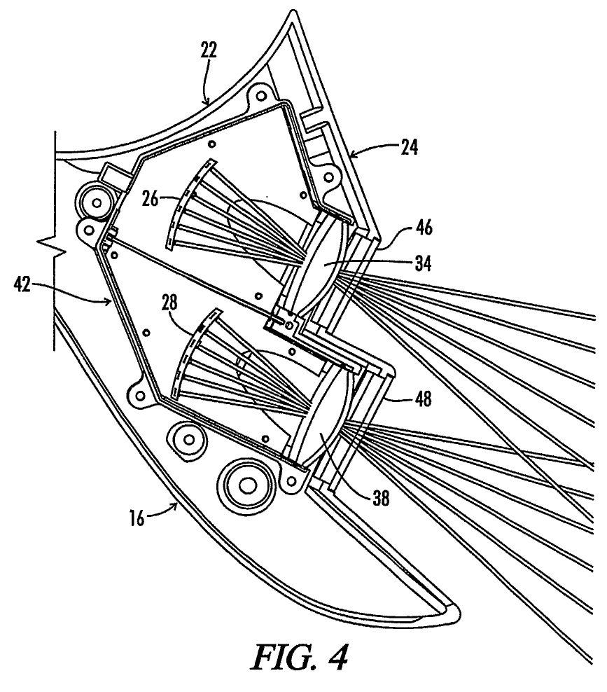

FIG. 4 is a plan view of the embodiment of the invention shown in FIG. 1, again with the cover removed from the SOD system enclosure.

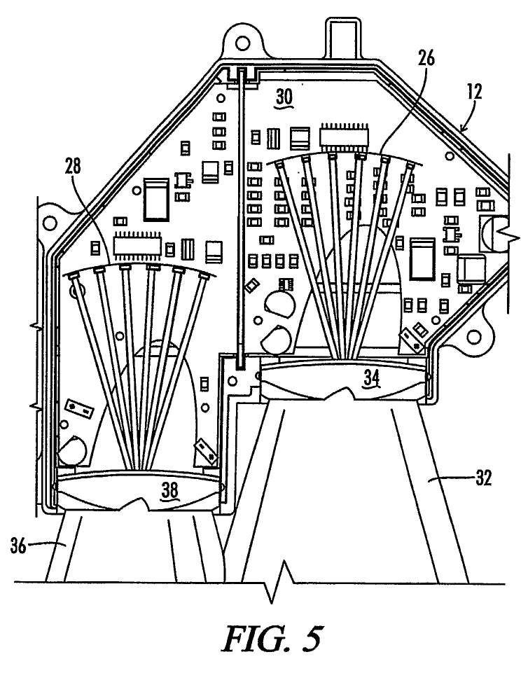

FIG. 5 is a top plan view of the embodiment of FIG. 1, with the cover removed from the SOD system enclosure to expose the arrangement of components on the SOD system board.

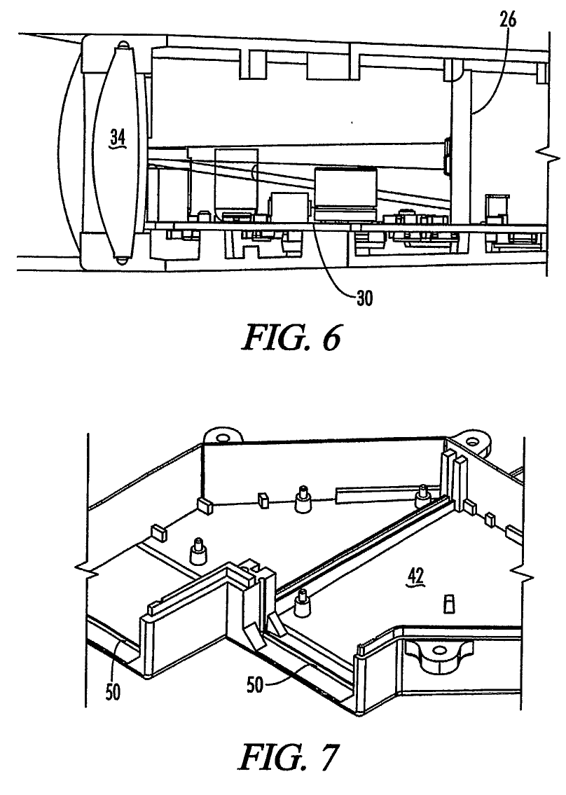

FIG. 6 is a cutaway side view of the embodiment of FIG. 1.

FIG. 7 is an enlarged top perspective view of the SOD system enclosure with the cover and lenses removed.

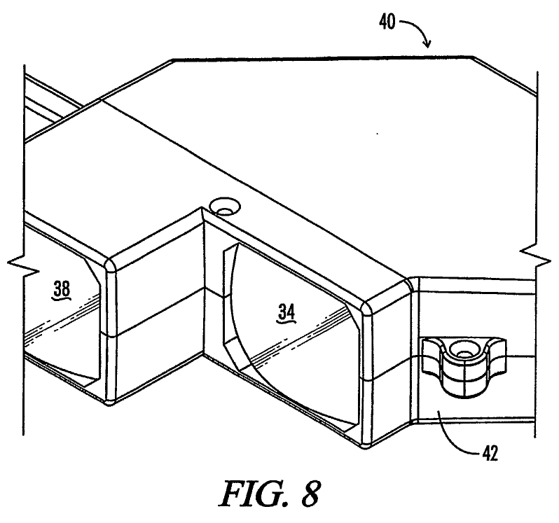

FIG. 8 is a top perspective view of the SOD system enclosure with the cover and lenses attached.

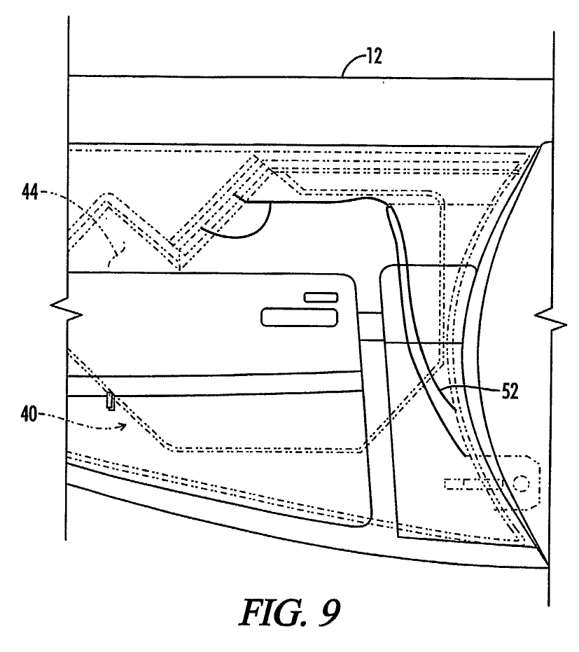

FIG. 9 is a top view of the vehicle side mirror assembly, showing in phantom the integral SOD system enclosure mounted therein in accordance with the present invention.

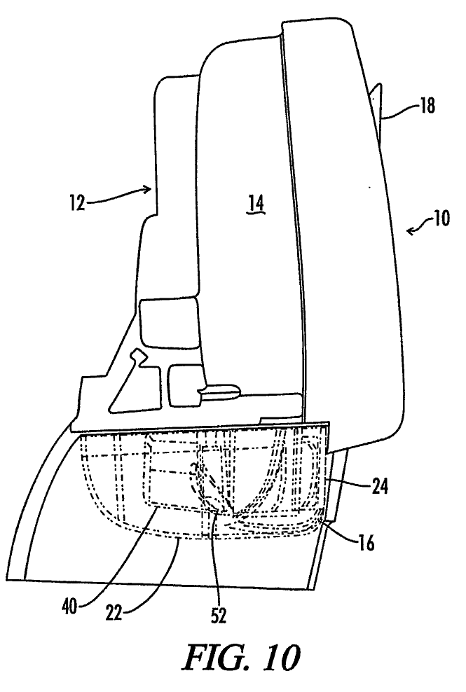

FIG. 10 is a side view of the vehicle side view mirror assembly of FIG. 9, showing in phantom the SOD system enclosure mounted therein.

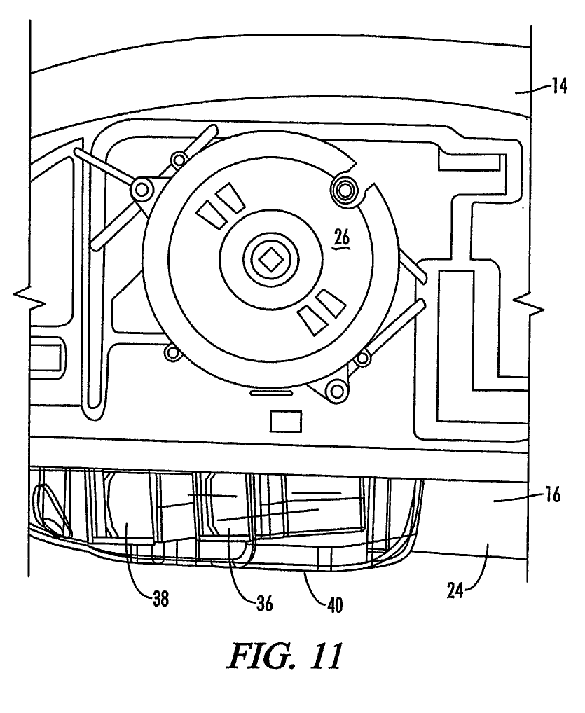

FIG. 11 is a rear (mirror-side) view of the vehicle side view mirror assembly of FIG. 9, with the mirror removed from the housing.

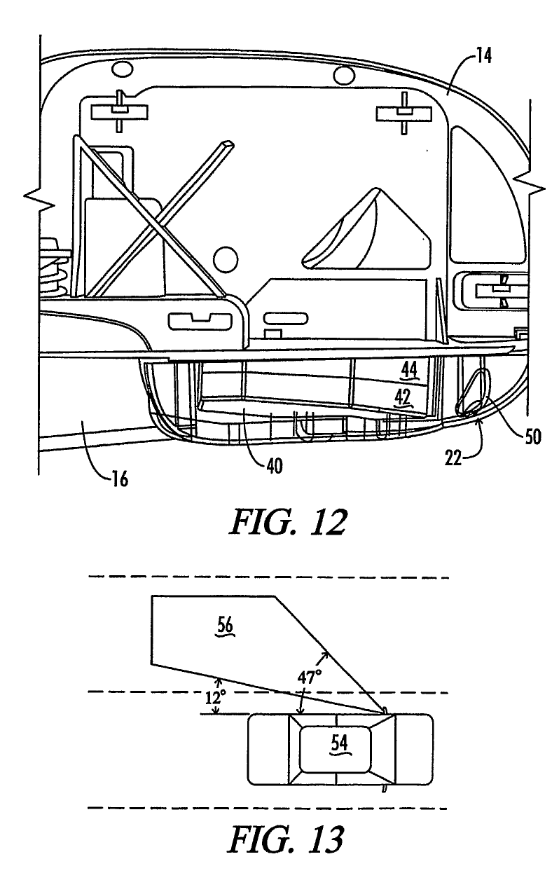

FIG. 12 is a front view of the vehicle side view mirror assembly of FIG. 9, with the housing front cover removed, and further showing the SOD system enclosure in phantom view.

FIG. 13 shows a side view mirror assembly attached to the side of a motor vehicle with a SOD system monitored zone extending along the side of the vehicle. This figure shows the left hand side only for clarity. The right side is approximately symmetrical.

### BEST MODE FOR CARRYING OUT THE INVENTION

Looking first at FIGS. 9, 10, 11 and 12, a vehicle side view mirror assembly 10 is shown. The assembly 10 includes a mirror frame or housing 12 which can have a top section 14 and a bottom section 16. The mirror 18 is mounted in a central location to the top section 14 of the housing 12. As best seen on FIG. 11, located behind the mirror (not shown) in a cavity of the within the mirror housing 12 is a mechanical assembly 20 which is controlled (electrically or mechanically) by the driver to orient the mirror to a preferred viewing angle. FIG. 12 shows the mirror housing 12 with the front panel removed.

The bottom section 16 of the housing 12 includes an exterior frame/housing wall 22. When the mirror assembly 10 is properly mounted to the vehicle (54 on FIG. 13), the housing 12 extends away from the side of the vehicle and a rearward facing segment 24 of the wall 22 faces down the side and toward the rear of the vehicle.

A side object detection (SOD) system is integrally attached to the mirror assembly 10. Referring to FIGS. 1-8, and as best seen in FIGS. 4 and 5, the SOD system includes an optical transmitter 26 and an optical receiver 28 mounted on and/or electrically coupled to a SOD system board 30. The transmitter 26 emits detection beams 32 through a transmitter lens 34. Returned detection beams 36 pass through a receiver lens 38 to the receiver 28. As best seen in FIGS. 5 and 6, the system board 30 includes logic (hardware and software) to cause the transmitter 26 to emit detection beams having power levels, frequencies, and timing that are collectively predetermined to define a monitored zone along the side of the vehicle. One example of a monitored (sensing) zone 56 is shown in FIG. 13 with reference to vehicle 54. The system board 30 also controls the receiver 28 and processes signals corresponding to the returned detection beams 36 to determine if and when an object is present in the monitored zone. The system board 30 can be a single printed circuit board with electronic components mounted thereon or multiple boards electrically coupled together. There are a variety of known techniques for generating and processing optical signals for purposes of object detection. One preferred detection method and SOD system is described in U.S. Pat. No. 6,377,167.

The SOD system components, including the transmitter 26, transmitter lens 34, receiver 28, receiver lens 38, and system board 30 are mounted in a SOD system enclosure 40 (FIG. 8). One embodiment of the enclosure 40 is formed from two pieces, a base section 42 and a cover 44. As best seen on FIG. 2, the entire SOD system enclosure 40 fits inside the bottom section 16 of the mirror housing 12, with the transmitter and receiver lenses 34, 38 aligned with and forming a part of the rearward facing segment 24 of the wall 22. Preferably, as best seen in FIG. 4, the portions of the rearward facing wall segment 24 defined by the lenses 34, 38 are staggered front and rear to provide increased optical isolation between the transmitter 26 and receiver 28. As shown most clearly on FIG. 3, the transmitter and receiver lenses 34, 38 preferably include respective lens covers 46, 48 to protect the optical elements of the lenses from accidental damage, and minimize the effects of the visible light spectrum on the photodetectors in the transmitter. The lens covers 46, 48 slide into slots 50 (FIG. 7) formed in the base 42 of the SOD enclosure 40.

FIGS. 10 and 12 show the complete mirror assembly 10 with the SOD system enclosure 40 (revealed in phantom for purposes of illustration) contained entirely within the cavity of the bottom section 16 of the mirror frame or housing 12. FIGS. 11 and 12 show how the integration of the SOD system components into the mirror assembly 10 preserves and does not expand the visual profile of the mirror housing 12. FIG. 9 shows the SOD system cable 52 extending from the enclosure 40 so that the SOD system can be connected to the vehicle DC electrical bus (not shown) to receive power and, optionally, to communicate with the vehicle's internal control network. In a preferred embodiment of the invention, the only component of the SOD system that is not entirely contained within the mirror housing 12 is the system cable 52.

FIG. 13 shows the mirror assembly 10 mounted to and extending away from the side of an automobile 54. As described in more detail above, the SOD system that is mounted integrally to the mirror housing 12 is used to detect objects that enter the monitored zone 56.

Although the embodiment of the invention illustrated herein shows the system enclosure 40 and system board 30 mounted entirely within the bottom section 16 of the mirror frame or housing 12, other mounting configurations can be used without departing from the scope of the invention. For example, some or all of the system hardware can be located in the cavity space behind the mirror in the top section 14 of the housing 12. In such an embodiment, the transmitter 26 and receiver 28 can be positioned behind the lenses 34, 38 as shown and electrically coupled to the system board 30 using cabling internal to the housing 12. Alternatively, the transmitter 26 and receiver 28 can remain part of the system board 30 with light pipes (not shown) optically coupling the transmitter 26 and receiver 28 to their respective lenses 34, 38.

Thus, although there have been described particular embodiments of the present invention of a new and useful “Side Mounted Vehicle Mirror with Integral Object Detection System”, it is not intended that such references be construed as limitations upon the scope of this invention except as set forth in the following claims.

1. A side rear view mirror apparatus for a motor vehicle comprising:
a. a frame attached to and extending away from a side of the vehicle;
b. a mirror disposed in a central portion of the frame;
c. the frame comprising an exterior frame wall adjacent to the mirror and an interior frame cavity, the frame wall including one or more rearward facing segments;
d. a side object detection system mounted in the frame, the side object detection system comprising an optical transmitter, an optical receiver, and a system board electrically coupled to the optical transmitter and to the optical receiver;
e. the optical transmitter including a lens integral to at least one of the rearward facing segments of the frame wall;
f. the optical receiver including a lens integral to at least one of the rearward facing segments of the frame wall; and
g. the system board is positioned within the frame cavity.

2. The apparatus of claim 1 wherein the vehicle has a vehicle electrical bus, the side object detection system further comprises a system cable electrically connecting the system board to the vehicle electrical bus, and wherein only the system cable component of the side object detection system extends outside of the frame.

3. A side rear view mirror apparatus for a motor vehicle comprising:
a. mirror housing attached to a side of the vehicle;
b. a mirror mounted to the housing;
c. the housing including a bottom section positioned below the mirror, the bottom section including a rearward facing exterior wall and an inner cavity;
d. a side object detection system comprising a transmitter, a transmitter lens, a receiver, a receiver lens, and a system board electrically connected to the transmitter and receiver;
e. the transmitter, receiver, and system board each positioned entirely within the inner cavity of the bottom section of the housing; and
f. the transmitter lens and receiver lens each defining portions of the exterior wall.

4. A mirror apparatus for a motor vehicle comprising:
a. a frame attachable to an exterior portion of the vehicle;
b. a mirror disposed in the frame;
c. the frame comprising a frame wall and a frame cavity;
d. a side object detection system mounted to the frame, the side object detection system comprising an optical transmitter and an optical receiver;
e. the optical transmitter including a transmitter lens projecting rearwardly from the frame wall; and
f. the optical receiver including a receiver lens projecting rearwardly from the frame wall.

5. The mirror apparatus of claim 4 further comprising a system board positioned within the frame cavity.

6. The mirror apparatus of claim 4 wherein the transmitter lens and receiver lens are integral to the frame wall.

7. The mirror apparatus of claim 6 wherein the optical transmitter is physically and optically separated from the optical receiver within the frame.

8. The mirror apparatus of claim 6 wherein the transmitter lens and the receiver lens are integral to respective non-coplanar sections of the frame wall.

9. The mirror apparatus of claim 4 wherein the mirror frame is attachable to a side of the motor vehicle.
